(19) United States
(12) Patent Application Publication
(10) Pub. No.: US 2012/0197787 A1
(43) Pub. Date: Aug. 2, 2012

(54) MOBILE WALLET EXPERIENCE FOR RESOLVING CONFLICTS BETWEEN DIFFERENT FINANCIAL INSTITUTIONS AND PAYMENT VEHICLES

(75) Inventors: David M. Grigg, Rock Hill, SC (US); Marc B. Keller, Charlotte, NC (US)

(73) Assignee: BANK OF AMERICA CORPORATION, Charlotte, NC (US)

(21) Appl. No.: 13/017,980

(22) Filed: Jan. 31, 2011

(51) Int. Cl. G06Q 40/00

(52) U.S. Cl. 705/40; 705/43

(57) ABSTRACT

In general, apparatuses, methods and computer program products for making contactless financial transactions utilizing a mobile wallet are disclosed. Particularly, a mobile wallet experience is disclosed. The experience aids to resolve conflicts between numerous payment vehicles and, particularly, financial institution-specific programs or sub-experiences on a mobile device. The mobile wallet experience permits a user to freely navigate various payment vehicles and, importantly, navigate efficiently through a plurality of financial institution sub-experiences.

### BACKGROUND

In today's “digital age,” more and more processes are becoming digital or automated. This is especially true in the financial industry. Over the years, primary methods for payment have evolved from cash to checks to credit and debit cards. More recently, technology has become available that permits for “contactless” transactions. For instance, a contactless payment is a payment where a customer pays a purchase amount without handing a payment card or a payment device to a cashier at the point-of-sale (POS) and without swiping the magnetic stripe of a payment card through a payment terminal (also sometimes referred to as a POS terminal). In other words, a contactless payment is one made using a payment device that may wirelessly transmit payment information to the payment terminal. Although physical contact between the payment device and the payment terminal may still occur in a contactless payment environment, physical contact between the payment device and the payment terminal is not necessary for transmission of the payment information from the payment device to the payment terminal.

Many payment terminals have the ability to read and process electronic payment information such as credit card or debit card information received wirelessly from a mobile device (e.g., a cell phone or other handheld computer) that is brought close to the payment terminal. Mobile devices configured with contactless transaction technology are often referred to as “mobile wallets” or “electronic wallets.”

A mobile device having mobile wallet capabilities may allow a user to use the mobile device's interface to select a payment vehicle that the user wishes to use for paying a purchase amount. Subsequently, the mobile device may transmit payment information associated with the selected payment vehicle when the mobile device is brought close to the payment terminal. A payment vehicle may be any payment instrument such as a credit account, debit account, bank card, or other instrument that can be used by one entity to pay another entity.

Furthermore, in today's age, users have many more “accounts” than in years past. Due to various reasons, such as numerous incentive-laden reward accounts, various “store” credit accounts that offer benefits to account holders, and simply the higher rate of debt in today's society, users may have numerous payment vehicles available to them for a given transaction.

With the increasing number of accounts held by users, problems begin to arise in properly categorizing, sorting, and maintaining the payment vehicles associated with the accounts within a single mobile device. This problem is compounded by financial institutions that issue the payment vehicles that wish to create their own financial institution “experience” for their contactless transactional users. A financial institution creating their own experience is understandable for reasons such as security, optimizing functionality with respect to the payment vehicles, creating opportunities to communicate with the user, etc. Unfortunately, problems arise in incorporating numerous financial institution experiences within a single device. As each experience is generally designed as separate application or program, the user is generally incapable of readily switching to different payment vehicles (from various financial institutions) within their entire mobile wallet. Furthermore, numerous similar functioning programs may lead to conflicts within the mobile device.

Thus, a need presently exists to produce a product capable of resolving conflicts between mobile wallet accounts in a secure manner that fundamentally organizes multiple financial institution experiences and other payment vehicles in a way that is convenient to the user and allows for the user to readily switch to different financial institution experiences in a seamless manner.

### SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention address the above needs and/or achieve other advantages by providing an apparatus (e.g., a system, computer program product, and/or other device), method, or a combination of the foregoing for making a financial transaction via a mobile device. Particularly, embodiments of the present invention are directed to resolving conflicts between numerous payment vehicles and financial institution experiences (applications, programs, etc.) on a mobile device. The mobile wallet experience of the present invention permits a user to freely navigate various payment vehicles and, importantly, financial institution “sub-experiences” without significant delay or conflict.

In a first embodiment of the invention, an apparatus for making a financial transaction is provided. The apparatus includes a memory device, a user interface configured to present information to a user, a communication device, and a processing device operatively coupled to the memory device and the communication device. The processing device is configured to execute computer-readable program code to display, via the user interface, a menu. The menu includes options selectable to the user. The options include at least one financial institution sub-experience. The processing device is further configured to execute computer-readable code to receive a menu selection request from the user to execute the at least one financial institution sub-experience. Additionally, the processing device is further configured to execute computer-readable code to generate a secure connection between the processing device and a secure module where the secure module is associated with the selected financial institution sub-experience. Furthermore, the processing device is further configured to execute computer-readable code to display, via the user interface, the at least one financial institution sub-experience. Moreover, the processing device is further configured to execute computer-readable code to receive instructions from the user accessing the at least one financial institution sub-experience to transmit payment vehicle data to an external apparatus. Finally, the processing device is further configured to execute computer-readable code to transmit the payment vehicle data wirelessly to the external apparatus.

In specific embodiments of the apparatus, the apparatus is a mobile phone.

In some specific embodiments of the apparatus, the secure module is integrated into a chip in the apparatus. In some embodiments, the secure module is stored in a memory in the chip.

In further specific embodiments of the apparatus, the external apparatus is a terminal configured to perform contactless transactions.

In some embodiments of the apparatus, the apparatus is configured to be capable of near field communication (NFC).

In still further embodiments of the apparatus, the external apparatus is a contactless payment terminal. In other embodiments, the external apparatus may be an automated teller machine (ATM).

In further specific embodiments of the apparatus, the options selectable to the user comprise more than one financial institution sub-experience. In some embodiments, the apparatus is configured such that the processing device may generate a secure connection to a unique secure module for each financial institution sub-experience. Each of the financial institution sub-experience and/or the associated secure module includes data associated with at least one payment vehicle. The payment vehicle is authorized by the financial institution associated with the sub-experience.

In some embodiments of the apparatus, a plurality of secure modules are present on the same chip. In other embodiments, a plurality of modules are distributed among more then one chip.

In a particular embodiment of the apparatus, each financial institution sub-experience is configured to be compatible with an overall mobile wallet experience. In some embodiments, the processing device may be further configured to execute computer-readable program code to receive instructions from the user to change menu selection from one financial institution sub-experience to a second financial institution sub-experience. Additionally, the processing device may be further configured to execute computer-readable program code to sever the secure connection between the processing device and the secure module. Finally, the processing device may be further configured to execute computer-readable program code to generate a second secure connection between the processing device and a second secure module. The second secure module is associated with the second financial institution sub-experience.

In some specific embodiments of the apparatus, the processing device is configured to execute computer-readable program code to display, via the user interface, more than one financial institution sub-experience and payment vehicle data for payment vehicles not associated with any of the financial institution sub-experiences.

In another specific embodiment of the apparatus, the processing device is configured to execute computer-readable program code to require security authorization from the user prior to displaying the menu, and no further security authorization is required to access the at least one financial institution sub-experience.

In a further aspect to the present invention, a method for making a financial transaction is provided. The method includes executing, on a mobile device, a mobile wallet experience. The mobile device includes a memory device, a user interface, a communication device, and a processing device. The mobile wallet experience includes a menu of options selectable to a user where the options include at least one financial institution sub-experience. The method further includes selecting an option to engage a financial institution sub-experience. Additionally, the method includes selecting a payment vehicle to utilize for the financial transaction. Finally, the method includes transmitting payment vehicle data associated with the payment vehicle wirelessly to an external apparatus.

In some specific embodiments of the method, the mobile device is a mobile phone.

In still further specific embodiments of the method, upon selecting to engage a financial institution sub-experience, a secure connection is formed between the processing device and a secure module. In some embodiments, the secure module is integrated into a chip in the mobile device. In some embodiments, the secure module is stored in a memory in the chip.

Furthermore, in some specific embodiments of the method, the external apparatus is a terminal configured to perform contactless transactions.

In particular embodiments of the method, the mobile device is configured to be capable of near field communication (NFC).

In further specific embodiments of the method, the external apparatus is a contactless payment terminal. In other embodiments, the external apparatus is an automated teller machine (ATM).

In some embodiments of the method, the options selectable to the user comprise more than one financial institution sub-experience. In some embodiments, the mobile device is configured such that processing device may generate a secure connection to a unique secure module for each financial institution sub-experience. Each financial institution sub-experience and/or the associated secure module include data associated with at least one payment vehicle. The payment vehicle is authorized by the financial institution associated with the sub-experience.

In some embodiments of the method, a plurality of secure modules are present on the same chip. In other embodiments, a plurality of secure modules are distributed among more than one chip.

In particular embodiments of the method, each financial institution sub-experience is configured to be compatible with the mobile wallet experience.

In some particular embodiments, the method further includes changing from engaging one financial institution sub-experience to engaging a second financial institution sub-experience. In some embodiments, the method still further includes that wherein upon changing, a first secure connection between the processing device and a first secure module is severed, and a second secure connection between the processing device and a second secure module is formed. The second secure module is associated with the second financial institution sub-experience.

In a further particular embodiment of the method, the menu of options selectable to the user include more than one financial institution sub-experience and payment vehicle data for payment vehicles not associated with any of the financial institution sub-experiences.

Additionally, in another specific embodiment of the method, the mobile wallet experience requires security authorization from the user, and no further security authorization is required to access the at least one financial institution sub-experience.

In yet another aspect of the present invention, a computer program product for making a financial transaction via a mobile device is provided. The computer program product includes a non-transitory computer-readable medium. The computer program product further includes a set of code for executing, on a mobile device, a mobile wallet experience configured to be capable of presenting a menu of options selectable to a user. The options include more than one financial institution sub-experience. The financial institution sub-experiences are configured to be compatible with the mobile wallet experience such that a user may freely switch between financial institutions sub-experiences without significant delay or conflict. The set of code is further configured to form a secure connection between a processing device and a secure module upon selection of a financial institution sub-experience by the user. The set of code is still further configured to sever the connection between the processing device and the secure module upon instruction from the user to change from the financial institution sub-experience to a second financial institution sub-experience. The set of code is additionally configured to generate a second secure connection to a second secure module. The second secure module is associated with the second financial institution sub-experience. Finally, the set of code is further configured to transmit payment vehicle data associated with a payment vehicle wirelessly to an external apparatus.

In some specific embodiments of the computer program product, the mobile device is a mobile phone.

In further specific embodiments of the computer program product, the secure modules are integrated into a chip in the mobile device. In some embodiments, the secure modules are stored in a memory in the chip.

In some specific embodiments of the computer program product, the set of code is configured to transmit the payment vehicle data via near field communication (NFC).

In still further embodiments of the computer program product, the external apparatus is a contactless payment terminal. In other embodiments, the external apparatus is an automated teller machine (ATM).

Additionally, in a further specific embodiment of the computer program product, the menu of options selectable to the user additionally comprise payment vehicle data for payment vehicles not associated with any of the financial institution sub-experiences.

In a specific embodiment of the computer program product, the set of code is configured to require security authorization from the user to access the mobile wallet experience, and no further security authorization is required in order to access the financial institution sub-experiences.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 illustrates a block diagram illustrating a contactless payment environment, in accordance with an embodiment of the invention;

FIG. 2 illustrates a block diagram illustrating the payment terminal of FIG. 1, in accordance with an embodiment of the invention;

FIG. 3 illustrates a block diagram illustrating a mobile wallet experience, in accordance with an embodiment of the invention;

FIG. 4 illustrates a block diagram illustrating the mobile device of FIG. 1, in accordance with an embodiment of the invention;

FIG. 5 illustrates a block diagram illustrating the mobile device of FIG. 1, in accordance with another embodiment of the invention;

FIG. 6 illustrates a block diagram illustrating a mobile wallet experience with a plurality of financial institution sub-experiences, each sub-experience with an independent communication to secure modules within a mobile wallet chip/memory, in accordance with another embodiment of the invention;

FIG. 7 is a high level flow diagram of a method for making a contactless financial transaction, in accordance with an embodiment of the present invention; and

FIG. 8 is a high level flow diagram of a method for making a contactless financial transaction, in accordance with an embodiment of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In accordance with embodiments of the invention, the term “entity” may refer to a seller, merchant, or the like, that offers contactless payment as a method of paying for a purchase associated with the entity. In accordance with embodiments of the invention, the term “user” may refer to a customer or the like, who makes a payment at a payment terminal associated with an entity. In accordance with embodiments of the invention, the term “tapping” may refer to bringing a mobile device close to or within the proximity of a payment terminal so that information can be communicated wirelessly between the mobile device and the payment terminal using short range wireless transmission technology, such near-field communication (NFC) technology, radio-frequency (RF) technology, or the like. Tapping may include physically tapping the mobile device against an appropriate portion of the payment terminal or it may include only waving or holding the mobile device near an appropriate portion of the payment terminal without making physical contact with the payment terminal.

In accordance with embodiments of the invention, the term “payment vehicle” may refer to an electronic payment vehicle, such as an electronic credit or debit card. The payment vehicle may not be a “card” at all and may instead be account identifying information stored electronically in a mobile device, such as in a cell phone. In accordance with embodiments of the invention, the term “module” with respect to an apparatus may refer to a hardware component of the apparatus, a software component of the apparatus, or a component of the apparatus that comprises both hardware and software. In accordance with embodiments of the invention, the term “chip” may refer to an integrated circuit, a microprocessor, a system-on-a-chip, a microcontroller, or the like that may either be integrated into the mobile device or may be inserted and removed from the mobile device by a user. In accordance with embodiments of the invention, the phrase “mobile wallet” refers to the hardware and/or software in a mobile device that enables the mobile device to be used to make contactless payments at a payment terminal.

In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like. In accordance with embodiments of the invention, the term “experience” or “mobile wallet experience” refers to a mobile application or program or computer code for maintaining and organizing payment vehicles including financial institution sub-experiences. In accordance with embodiments of the invention, the term “sub-experience” or “financial institution sub-experience” refers to executable computer code designed by or at the direction of the financial institution that was specifically designed for or is otherwise compatible with the mobile wallet experience of the present invention. The compatibility assures seamless transition from one sub-experience to another without significant delay or conflict within the mobile wallet experience

In general, embodiments of the present invention relate to apparatuses, methods and computer program products for making contactless financial transactions. More specifically, the present invention is directed to resolving conflicts between numerous payment vehicles and financial institution experiences (applications, programs, etc.) on a mobile device. The mobile wallet experience of the present invention permits a user to freely navigate various payment vehicles and, importantly, financial institution sub-experiences.

As a general matter, various financial institutions, card issuers, payment network providers, sponsors, etc. prefer to design their own user experience and utilize their own security protocols for interacting with a user in a financial transaction. A given user may have relationship with a large number of such financial institutions, card issuers, sponsor, etc., which would require the user to download and separately maintain user experience applications for each of these relationships. As mentioned, this can be cumbersome and tedious.

In recognition of the above, generally, the present invention provides a mobile wallet system that collects and organizes the various card-specific experiences into a user friendly interface. The mobile wallet operates as an overarching system within which the user can access the various card-specific experiences. At a first level, the mobile wallet may operate as an initial interface listing each of the card-specific experiences. The mobile wallet allows the user to navigate between and select a specific experience, which, in turn, launches the experience for use by the user. The selected experience may run either within the mobile wallet or as a separate program depending on the embodiment. Either parameters for communicating with the mobile wallet are provided to various institutions, card issuers, payment network provider, sponsors, etc. so that their experiences can be programmed to operate with the mobile wallet or visa versa the mobile wallet is configured to operate with each individual experience.

In addition to providing a convenient interface for a plurality of experiences to the user, the present invention also provides to the various institutions, card issuers, payment network provider, sponsors, etc. associated with the experiences. The present invention allows these entities to create customized user experiences while allowing the user the ease of navigation, transition, switching, etc. between different experiences.

In addition to providing an overarching interface for navigation and selection of different experiences, the system also accommodates for different security protocols for each experience and facilitates easy transition to different experiences by the user during a given time via different security channels. The system maintains different security modules associated with each experience. When an experience is selected by the user, the system communicates with the institutions, card issuers, payment network provider, sponsors, etc. associated with the experience using the stored security module to facilitate the user requested transaction. If the user decides to perform a transaction via another experience, the system can transition to the new experience and to its associated security protocol by severing the current secure communication link and using the security module with the newly selected experience to facilitate a secure transaction between the user the institutions, card issuers, payment network provider, sponsors, etc. associated with the newly selected experience.

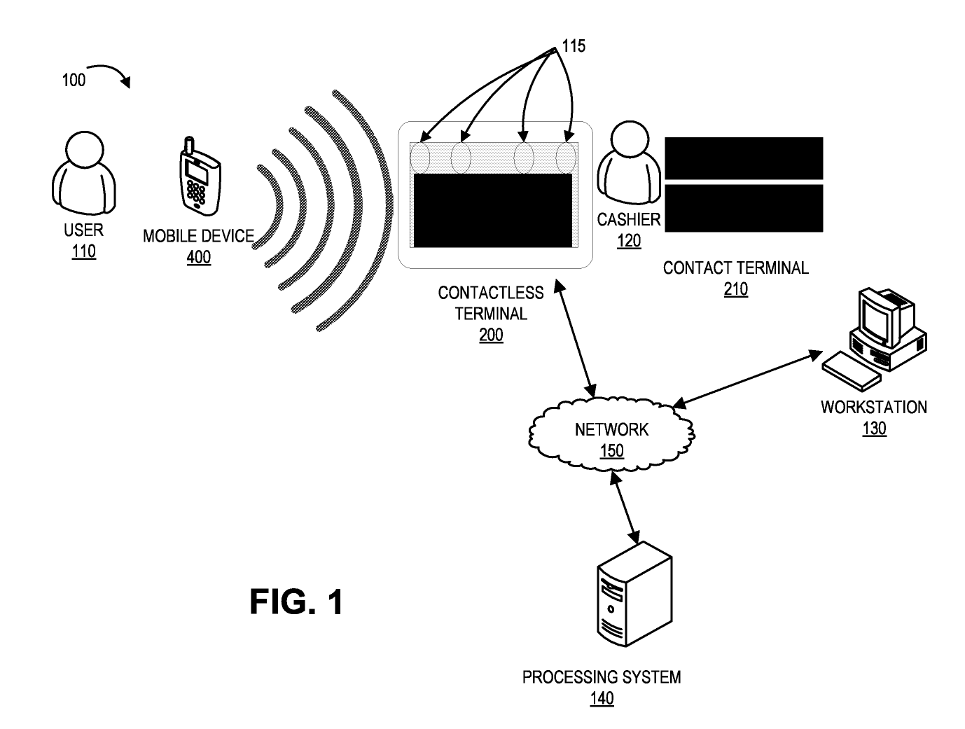

FIG. 1 provides a block diagram illustrating a contactless transaction environment 100 configured for making a contactless transaction via a mobile device. As illustrated, the contactless transaction environment 100 may include a mobile device 400 operable by a user 110 who may be a customer who wants to make a contactless payment or other transaction via a mobile device 400. The contactless transaction environment 100 may also include a contactless terminal 200 that may be automated or may be operable by a cashier 120. The contactless terminal 200 may permit a user to make a contactless payment or transaction with a transaction device such as the mobile device 400.

The environment 100 may also include a contact terminal 210 that may permit a user to make a payment via a contact transaction device such as a payment card that has a magnetic stripe which may be swiped through the contact terminal 210 or other form of contact transaction, such as by a contact smart card.

The contactless transaction environment 100 may also include a workstation 130 and a processing system 140 that are in electronic communication with the contactless terminal 200 via a network 150, which may be the Internet, an intranet or the like. The user interface 115 situated on the contactless terminal may be any sort of device, such as a liquid crystal display (LCD) or light emitting diode (LED) display for indicating that payment has been received, invalid payment vehicle, exceeded credit limit, etc.

In FIG. 1, the network 150 may include a local area network (LAN), a wide area network (WAN), and/or a global area network (GAN). The network 150 may provide for wireline, wireless, or a combination of wireline and wireless communication between devices in the network. In some embodiments, the network 150 includes the Internet. In some embodiments, the network 150 may include a wireless telephone network.

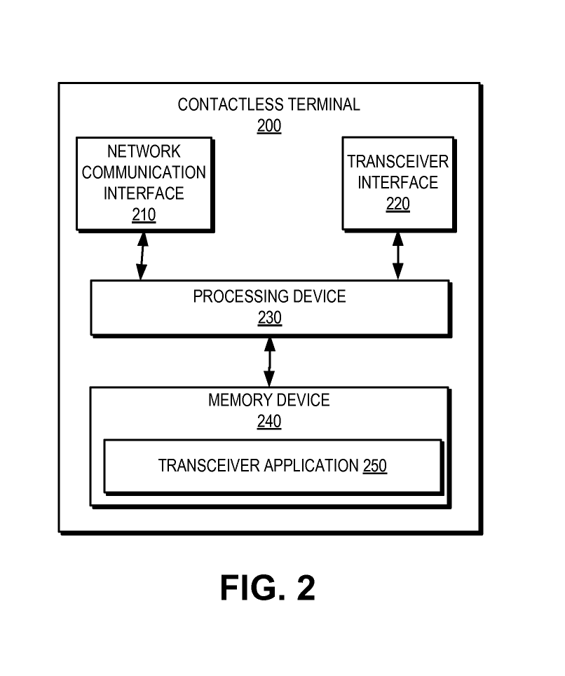

FIG. 2 displays an embodiment of a contactless terminal 200 that is depicted in FIG. 1. The contactless terminal 200 may include various features, such as a network communication interface 210, a processing device 230, a transceiver interface 220, and a memory device 240 that may include a transceiver application 250.

As used with respect to the contactless terminal 200, a “communication interface” may generally include a modem, server, transceiver, and/or other device for communicating with other devices on a network. The network communication interface may be a communication interface having one or more communication devices configured to communicate with one or more other devices in the contactless transaction environment 100, such as the mobile device 400, the workstation 130, the processing system 140, other processing systems, data systems, etc.

In one embodiment, the transceiver interface 220 is a separate module that may generally include a transceiver, i.e., one or more antennas and/or other electronic circuitry, devices, and software, for receiving electronic payment vehicle data when the mobile device is held close to or tapped at the contactless terminal 200. In some embodiments, the transceiver interface 220 is part of the network communication interface 210. Furthermore, the transceiver interface 220 may also be used as an interface to send data to the mobile device 400 when the mobile device 400 is held close to or tapped at the contactless terminal 200.

An output device for the transceiver interface 220 may include a display that provides instructions regarding the steps for making a contactless transaction. In some embodiments where the contactless terminal 200 requests the user's signature, the display may also serve as a touchpad input device to input the user's signature via a stylus. Other output devices may include one or more LEDs or an audio speaker, both which may indicate to the user that data has been successfully received from the mobile device 400. A printer that can print paper receipts may also be incorporated into the contactless terminal 200. Other embodiments of the contactless terminal 200 may carry other input and output devices, such as a mouse, keyboard, button, touchpad, touch screen, microphone, speaker, light, joystick, switch, or the like.

As used with respect to the contactless terminal 200, a “processing device,” 230 may generally refer to a device or combination of devices having circuitry used for implementing the communication and/or logic functions of a particular system. For example, a processing device 230 may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 230 may be configured to use the network communication interface 210 and/or the transceiver interface 220 to transmit and/or receive data and/or commands to and/or from the other devices that are visible in the contactless payment environment 100.

As used with respect to the contactless terminal 200, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein. In one embodiment, the memory device stores a transceiver application 250. The transceiver application 250 may work in conjunction with the previously described transceiver interface 220 to receive electronic payment vehicle data when the mobile device is held close to or tapped at the contactless terminal 200. In some embodiments, the transceiver application 250 may also be configured to send data to the mobile device when the mobile device is held close to or tapped at the payment terminal, or potentially provide a power source to the mobile device in the event the primary power source is depleted.

As illustrated in FIG. 1, a contactless terminal 200 may be connected to a workstation 130 via the network 150. The workstation 130 may be used by the cashier 120 or other personnel to interact with the contactless terminal 200. The workstation 130 may include various features, such as a network communication interface, a processing device, a user interface, and a memory device.

As used with respect to the workstation 130, a “communication interface” may generally include a modem, server, transceiver, and/or other device for communicating with other devices on a network. The network communication interface may be a communication interface having one or more communication devices configured to communicate with one or more other devices on the network 150, such as the contactless terminal 200 and/or contact terminal 210, the processing system 140, other processing systems, data systems, etc.

As used with respect to the workstation 130, a “processing device” may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device may be configured to use the network communication interface to transmit and/or receive data and/or commands to and/or from the other devices connected to the network 150.

As used with respect to the workstation 130, a “user interface” may generally include a plurality of interface devices and/or software that allow a user to input commands and data to direct the processing device to execute instructions. For example, the user interface may include a graphical user interface (GUI) or an interface to input computer-executable instructions that direct the processing device to carry out specific functions. The user interface may employ certain input and output devices to input data received from the user or the cashier 120 or output data to the user or the cashier 120. These input and output devices may include a display, mouse, keyboard, button, touchpad, touch screen, microphone, speaker, light, joystick, switch, and/or other customer input/output device for communicating with one or more customers. As used with respect to the workstation 130, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein.

As illustrated in FIG. 1, in a contactless transaction environment 100, a mobile device 400 is configured to wirelessly transmit payment vehicle data to a contactless terminal 200. Payment vehicle data is stored within the mobile device 400, as described further below. All payment vehicle data may simply be stored within the mobile wallet and the desired payment vehicle selectable to the user. However, many financial institutions have developed their own “experience” for use with only that financial institution's associated payment vehicles. An “experience” may be generally a software application or program or combination of hardware/software functionality. Thus, problems arise for users with a plurality of electronic payment vehicles associated with multiple financial institutions. With multiple payment vehicles accessible to the user through multiple financial institution experiences, the user may find it difficult to readily switch from one experience to another in able to access other desired payment vehicles. Furthermore, multiple financial institution experiences present within the same mobile device 400 may lead to problematic software/hardware conflicts causing some or all payment vehicles to be inaccessible or conflicts affecting other functionalities of the mobile device 400.

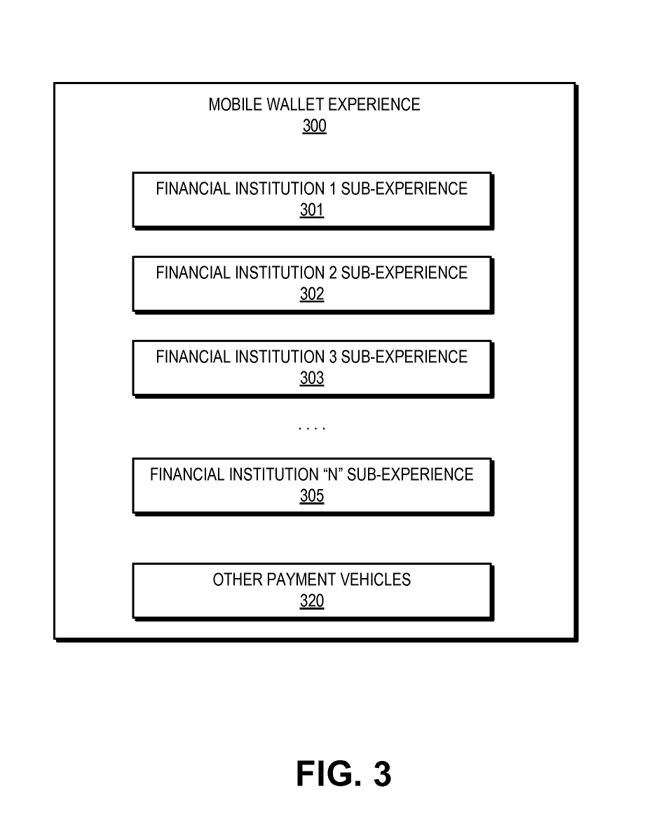

Referring to FIG. 3, a block diagram illustrating one embodiment of a mobile wallet experience 300 for a mobile device 400 is depicted. As illustrated, any number of financial institution sub-experiences may be contained within the mobile wallet experience 300. For instance, the mobile wallet experience 300 may include financial institution 1 sub-experience 301, financial institution 2 sub-experience 302, financial institution 3 sub-experience 303, and up to any number of financial institution “N” sub-experience 305 as illustrated. “N” may be any number desired, but will generally be from 0-20, such as 1-10, and in some embodiments 1-5. Further, as illustrated in FIG. 3, the mobile wallet experience 300 has the capability of including other payment vehicles 320 that a sub-experience is not available for or the user opts to not utilize the sub-experience(s) associated with the other payment vehicles 320.

The mobile wallet experience 300 allows the user to readily navigate through their mobile wallet including readily switching from one financial institution sub-experience to another without significant delay or conflict. Thus, a financial institution sub-experience 301 generally must be configured to be compatible with the mobile wallet experience 300. This gives the user the ability to readily cycle through payment vehicles within all sub-experiences without the need for executing entirely separate applications or programs which could include any number of conflicts and delays such as, for instance, logging out of a first financial institution application or program, provide authorization login data in a second financial institution application or program, a need to disconnect/reconnect between the user's mobile device 400 and a contactless transaction terminal 200, etc.

The mobile wallet experience 300 may be configured to display a menu to the user that includes selectable options for the user to select which financial institution sub-experience 301 and/or other payment vehicle 320 to engage in order to complete a financial transaction. The mobile wallet experience 300 may further include any number of additional features. For instance, in one embodiment, the mobile wallet experience 300 allows the user to set a default payment vehicle, which may be accessed through a financial institution sub-experience. The mobile wallet experience 300 may also provide the user with information relating to sub-experiences and/or the other payment vehicles 320. For instance, the mobile wallet experience 300 menu may include a summary of payment vehicles within each sub-experience or other data such as rewards program information for one or more payment vehicles (e.g., cash-back benefits for using a particular payment vehicle, rewards points, etc). Furthermore, in some embodiments, the mobile wallet experience 300 includes a security authorization input by the user upon initial execution of the mobile wallet experience 300. Upon authorization within the mobile wallet experience 300, the user should not generally have to include any further security authorizations in order to access financial institution sub-experiences or other payment vehicles.

The mobile wallet experience 300 may also be configured to provide a recommendation or automatically select a payment vehicle for the user in specified instances. For example, upon connection of the user's mobile device 400 with a contactless transaction terminal 200, the mobile wallet experience 300 may be configured to utilize data transmitted from the terminal 200 to select the appropriate payment vehicle. For instance, if the transaction terminal 200 is a financial institution automated teller machine (ATM), the mobile wallet experience 300 may recommend or automatically select a payment vehicle or financial institution sub-experience appropriate to transact with the ATM. In other instances, for example a transaction at a fuel station, grocery store, etc., the mobile wallet experience 300 may recommend or automatically select a payment vehicle that the user has indicated they intend to use for the particular type of transaction or the mobile wallet experience 300 may recommend or automatically select a payment vehicle that are enrolled in financial institution rewards programs for the particular type of transaction.

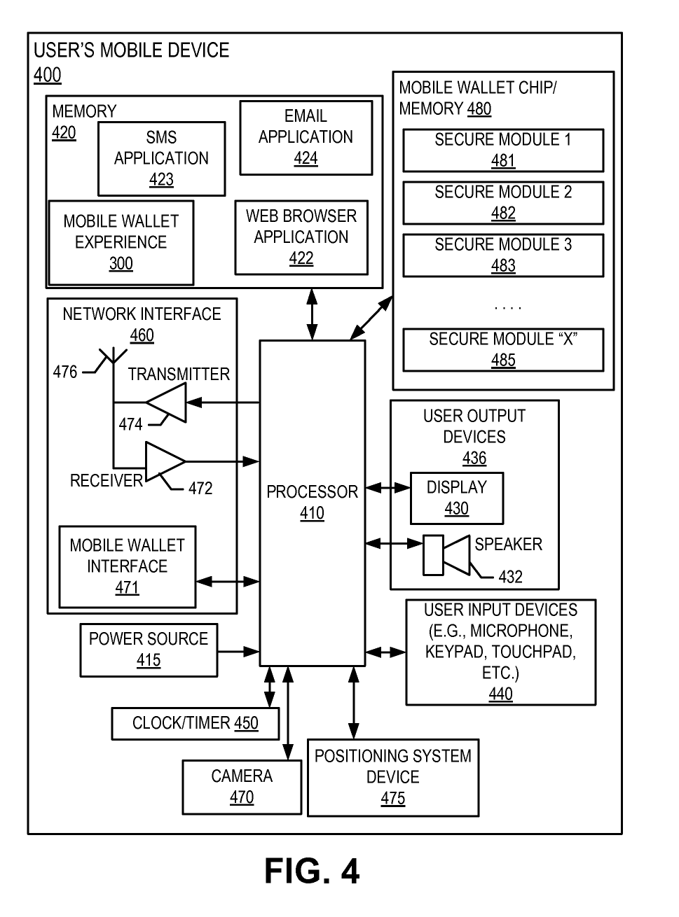

Turning now to FIG. 4, illustrated is an embodiment of a mobile device 400 that may be configured to make a contactless transaction at a contactless terminal 200. As used herein, a “mobile device” 400 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 400 may generally include a processor 410 communicably coupled to such devices as a memory 420, user output devices 436, user input devices 440, a network interface 460, a power source 415, a clock or other timer 450, a camera 470, a positioning system device 475, one or more mobile wallet chips/memory 480, etc. The processor 410, and other processors described herein, may generally include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 may be allocated between these devices according to their respective capabilities. The processor 410 thus may also include the functionality to encode and interleave messages and data prior to modulation and transmission. The processor 410 may additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 may also be capable of operating a client application, such as a mobile wallet experience or application 300. In one embodiment of the invention, the mobile wallet experience 300 may be downloaded from a server and stored in the memory 420 of the mobile device 400. In another embodiment, the mobile wallet experience 300 may be pre-installed and stored in the mobile wallet chip/memory 480. In such an embodiment, the user may not need to download the mobile wallet experience 300 from a server. In some embodiments, the mobile wallet experience 421 may have a graphical user interface (GUI) that allows the user to perform various processes as described below. The GUI may also allow the user to set certain payment preferences or mobile wallet preferences.

The mobile wallet chip/memory 480 may comprise a plurality of secure modules such as secure module 1 481, secure module 2 482, secure module 3 483, up to a secure module “X” 485 as desired. The mobile wallet chip/memory 480 may be an integrated circuit, a microprocessor, a system-on-a-chip, a microcontroller, or the like. In one embodiment, the mobile wallet chip 480 provides Near Field Communication (NFC) capabilities to the device 400.

Of note, while FIGS. 4-6 illustrate the mobile wallet chip/memory 480 as a separate and distinct element within the mobile device 400, it will be apparent to those skilled in the art that the mobile wallet chip/memory 480 functionality may be incorporated within other elements in the mobile device 400. For instance, the functionality of the mobile wallet chip/memory 480 may be incorporated within the mobile device memory 420. In a particular embodiment, the functionality of the mobile wallet chip/memory 480 is incorporated in an element within the mobile device 400 that provides NFC capabilities to the mobile device 400. However, it is not necessary for the mobile wallet chip/memory 480 to provide the NFC capabilities to the mobile device 400. The mobile device 400 may include a NFC providing element (and/or other wireless communication systems) (not shown) separate from the mobile wallet chip/memory 480.

Each secure module 481, 482, 483, 485 may be a memory device within the mobile wallet chip/memory 480. The secure module may comprise payment vehicle data associated with a plurality of payment vehicles. Alternatively, each secure module may comprise payment vehicle data associated with a single payment vehicle or financial institution sub-experience. The payment vehicle data may be data typical of standard card-type payment vehicles. For instance, payment vehicle data for each payment vehicle that is stored in the secure modules 481, 482, 483, 485 may include the payment vehicle type, the payment vehicle number, the name associated with the payment vehicle, the expiration date of the payment vehicle, the security code associated with the payment vehicle, whether the payment vehicle is a credit or debit payment vehicle, gift card payment vehicle, etc. Additionally, the secure module 481, 482, 483, 485 may comprise data indicating whether a payment vehicle is a default payment vehicle. In the embodiment depicted in FIG. 4, since the secure modules 481, 482, 483, 485 are stored in a memory in the mobile wallet chip/memory 480 and not in a memory 420 in the mobile device 400, the user may be able to transfer the mobile wallet chip 480, if the mobile wallet chip 480 is not irreversibly integrated into the mobile device 400, to another mobile device and the user may consequently have access to the payment vehicles and sub-experiences in the mobile wallet chip 480 on a different mobile device. Alternatively, the secure modules could be stored in secured sectors of memory 420 or other data storage of the mobile device 400 and be transferred to a new mobile device 400. Furthermore, the mobile wallet experience 300 and/or data within the secure modules may be additionally stored on an external apparatus or network to provide the user with the capability to readily transfer their mobile wallet system from one mobile device 400 to another or to restore their mobile wallet system to their device 400, if needed.

The processor 410 may be configured to use the network interface 460 to communicate with one or more other devices on the network 150. In this regard, the network interface 460 may include an antenna 476 operatively coupled to a transmitter 474 and a receiver 472 (together a “transceiver”). The processor 410 may be configured to provide signals to and receive signals from the transmitter 474 and receiver 472, respectively. These signals may include radio frequency signals emanating from the mobile device's transmitter 474 when the mobile device is tapped at or held or waved in close proximity to the contactless terminal 200. These signals may also include radio frequency signals received at the mobile device's receiver 472 when the mobile device is tapped at or held or waved in close proximity to the contactless terminal 200. In one embodiment, these radio frequency signals may be transmitted and received in the radio frequency band, such as 13.56 MHz. In one embodiment, the ISO/IEC 14443 standard may define the protocol associated with the data carried by these radio frequency signals. In one embodiment, the transmitter 474 and receiver 472 at the mobile device may transmit and receive radio frequency signals, respectively, from a payment terminal within a distance of up to 25 cm.

As indicated earlier, the processor 410 may be configured to provide signals to and receive signals from the transmitter 474 and receiver 472, respectively. The signals may also include signaling information in accordance with the air interface standard of the applicable cellular system of the wireless telephone network that may be part of the network 150. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN) or other communication/data networks.

The network interface 460 may also include a mobile wallet interface 471 in order to allow a user to execute some or all of the above-described processes with respect to the mobile wallet experience 300 and the secure modules 481, 482, 483, 485 of the mobile wallet chip/memory 480. The mobile wallet interface 471 may have access to the hardware, e.g., the transceiver, and software previously described with respect to the network interface 460.

The mobile device 400 may comprise a transceiver that works in conjunction with the secure modules 481, 482, 483, 485 of the mobile device 400. In one embodiment, the antenna and other hardware or software that transmit payment vehicle data from the secure module 481, 482, 483, 485 of the mobile device 400 may be integrated into the secure module 481, 482, 483, 485.

As described above, the mobile device 400 may have a user interface that includes user output devices 436 and/or user input devices 440. The user output devices 436 may include a display 430 (e.g., a liquid crystal display (LCD) or the like) and a speaker 432 or other audio device, which are operatively coupled to the processor 410. The user input devices 440, which may allow the mobile device 400 to receive data from a user 110, may include any of a number of devices allowing the mobile device 400 to receive data from a user, such as a keypad, keyboard, touch-screen, touchpad, microphone, mouse, joystick, other pointer device, button, soft key, and/or other input device(s).

The mobile device 400 may further include a power source 415. In one embodiment, a power source 415 is a device that supplies electrical energy to an electrical load. In one embodiment, a power source 415 may convert a form of energy such as solar energy, chemical energy, mechanical energy, etc. to electrical energy. In one embodiment, a power source 415 in a mobile device may be a battery, such as a lithium battery, a nickel-metal hydride battery, or the like, that is used for powering various circuits, e.g., the transceiver circuit, and other devices that are used to operate the mobile device 400. In some embodiments, the power source 415 may be a power adapter that can connect a power supply from a power outlet to the mobile device 400. In some embodiments, a power adapter may be classified as a power source “in” the mobile device.

The mobile device 400 may also include a memory 420 operatively coupled to the processor 410. As used herein, memory may include any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory may additionally or alternatively include an electrically erasable programmable read-only memory (EEPROM), flash memory or the like.

The memory 420 may store any of a number of applications or programs which comprise computer-executable instructions/code executed by the processor 410 to implement the functions of the mobile device 400 described herein. For example, the memory 420 may include such applications as a web browser application 422 and a mobile wallet experience 300. The mobile wallet experience 300 may be capable of performing one or more functions described above. These applications may also typically provide a graphical user interface (GUI) on the display 430. For instance, as described previously, the GUI for the mobile wallet experience 300 may allow the user 110 to enter input to select a payment vehicle or financial institution sub-experience to transmit to a contactless terminal 200.

The memory 420 may also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information to gain access to the mobile wallet experience 300, user authentication information for each payment vehicle that is stored by or accessible via the mobile wallet experience 421, user authentication information to access the secure modules 481, 482, 483, 485 of the mobile wallet chip/memory 480, etc. In other embodiments, this authentication information may be stored in a memory of the mobile wallet chip/memory 480.

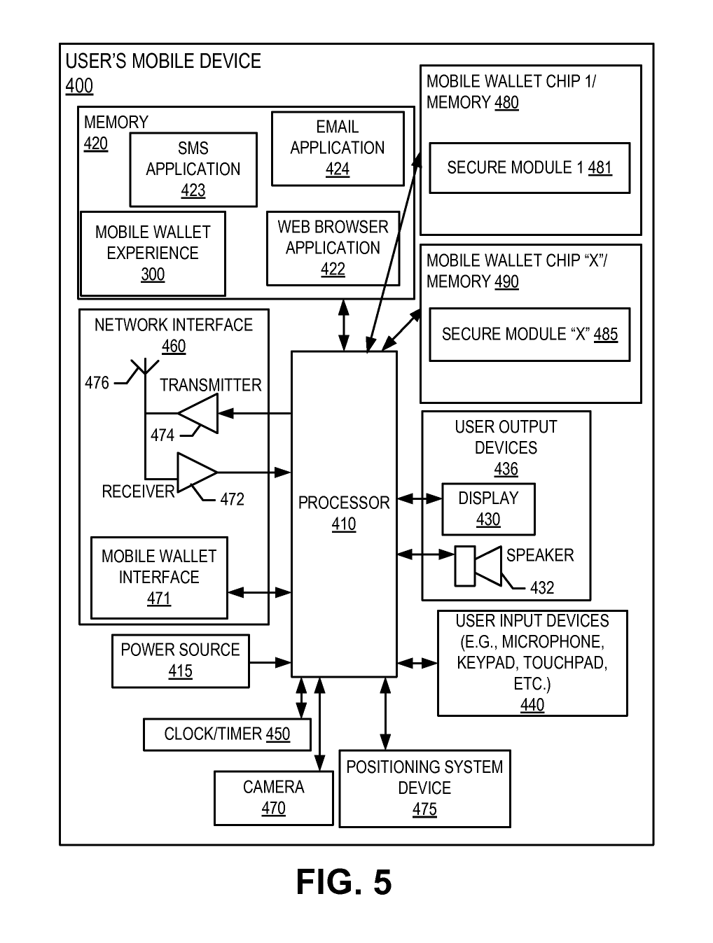

FIG. 5 displays an illustration of a further alternate embodiment of a mobile device 400 that comprises multiple mobile wallet chips/memory 480, 490. The first mobile wallet chip/memory 480 may comprise a secure module 481 as described in previous embodiments. The “Xth” mobile wallet chip/memory 490 may comprise an “X” secure module 485. As noted above, “X” may represent any number as desired.

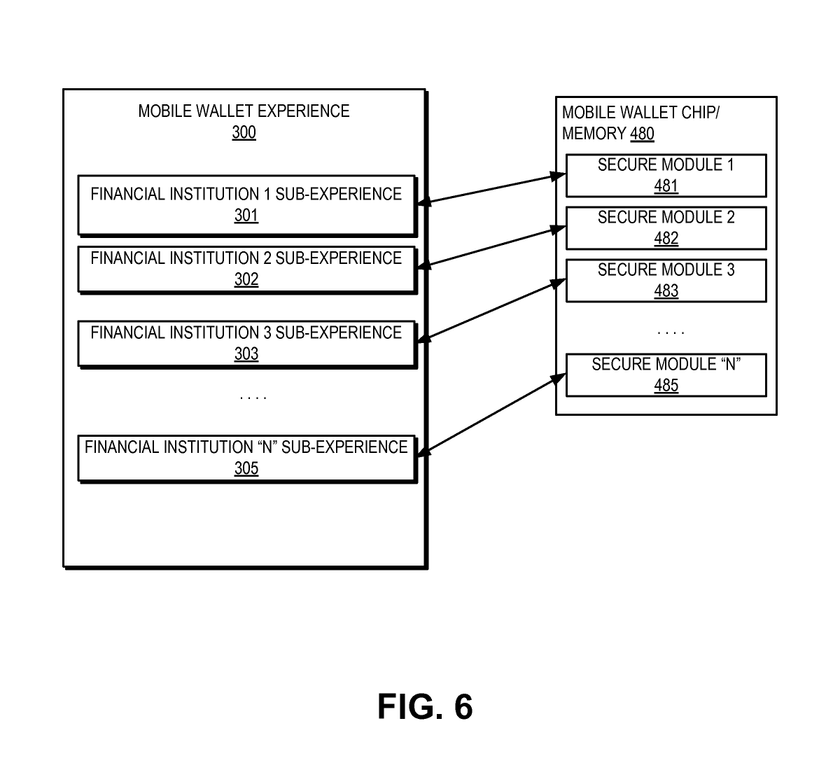

Referring to FIG. 6, an embodiment of the mobile wallet experience 300 with unique, independent connections between each financial institution sub-experience 301, 302, 303, 305 and secure modules 481, 482, 483, 485 on the mobile wallet chip/memory 480 is illustrated. Generally speaking, in most embodiments, independent operative connections between financial institution sub-experiences and the secure modules are desired. First, a financial institution sub-experience is likely to be developed independent of other financial institution sub-experiences. Thus, to ensure proper functionality of the sub-experiences, it may be desired for each sub-experience connection to the secure modules to be independent. Furthermore, such a construction further serves to enhance the security of the mobile wallet experience 300. Independent connections from the financial institution sub-experience limit the potential for information of one financial institution to be mistakenly transmitted to another financial institution. Furthermore, as noted above, generally speaking, each financial institution sub-experience is developed independently of the mobile wallet experience 300. Thus, operating the mobile wallet experience 300 across a single connection with the mobile wallet chip/memory 480 could lead to various functional conflicts between financial institution sub-experiences.

As such, it is generally desired that each financial institution sub-experience 481, 482, 483, 485 be configured to include an independent connection to the secure modules in the mobile wallet chip/memory 480. Thus, in such embodiments, if a user engages a financial institution sub-experience, an independent operative communication connection between the sub-experience and its corresponding secure module is formed (via the processor 410). If the user opts to switch from the active financial institution sub-experience to a second financial institution sub-experience, the communication connection is severed and a different, independent connection is formed between the second financial institution sub-experience and its corresponding secure module.

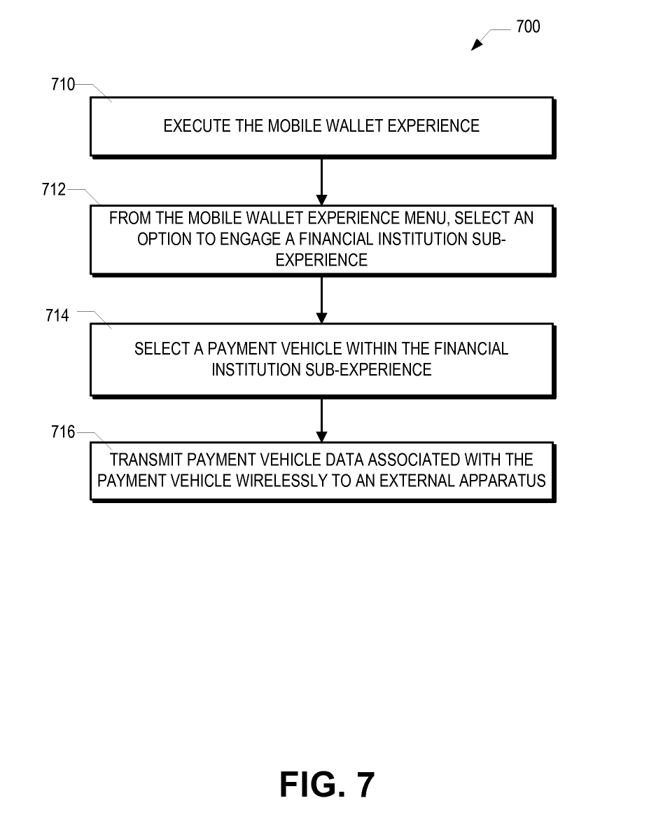

Referring now to FIG. 7, illustrated is a high level flow diagram of a method 700 for making a contactless financial transaction. At block 710, the mobile wallet experience 300 is executed on the mobile device 400. Executing the mobile wallet experience 300 may require some degree of user authentication prior to obtaining the selection menu. At block 712, from the mobile wallet experience menu, the user has the option to engage a financial institution sub-experience. Upon selecting a financial institution sub-experience, at block 714, the user may select the desired payment vehicle to complete the transaction. Oftentimes, the user may only have a single payment vehicle associated with a particular financial institute sub-experience, but, of course, a user may have numerous payment vehicles associated with the same sub-experience. Finally, upon selecting the payment vehicle, at block 716, the payment vehicle data is transmitted wirelessly to an external apparatus. The external apparatus may generally be a contactless transaction terminal such as an ATM, payment terminal, or the like.

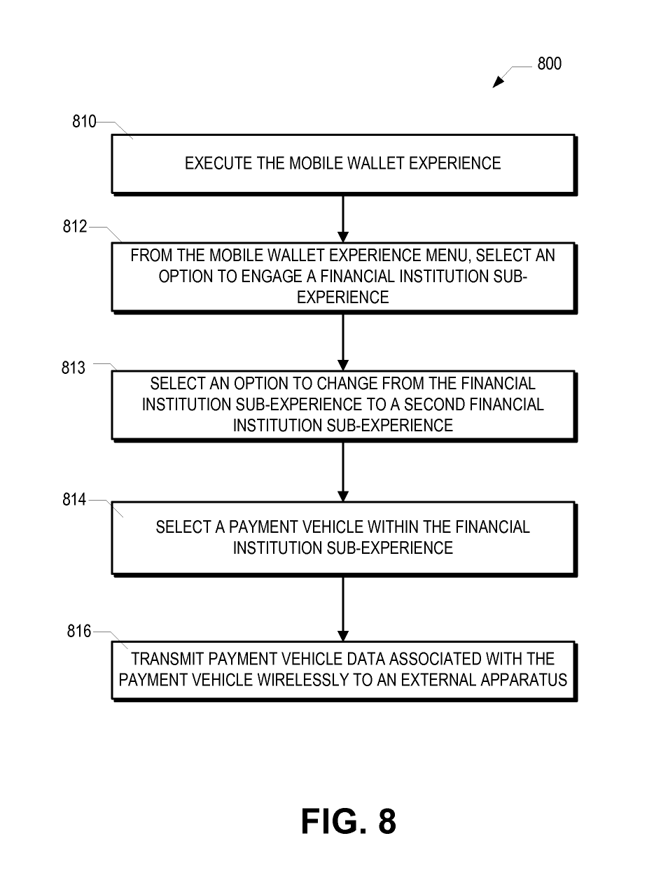

At FIG. 8, illustrated is another high level flow diagram of a method 800 for making a contactless financial transaction. At block 810, the mobile wallet experience 300 is executed on the mobile device 400. As described at block 812, from the mobile wallet experience menu, the user may opt to engage a financial institution sub-experience. In most embodiments, upon engaging a financial institution sub-experience, an independent connection is formed between the sub-experience and a secure module located within the mobile chip/memory 480. At block 813, the user opts to change from the active financial institution sub-experience to a second financial institution sub-experience. After making the selection, the active link between the first financial institution sub-experience and the secure module is severed and a second independent communication link is formed between the second financial institution sub-experience and a secure module. Finally, again, upon selecting the payment vehicle, at block 816, the payment vehicle data is transmitted wirelessly to an external apparatus such as an ATM, contactless payment terminal, etc.

The mobile wallet application is configured to help the user manage payment information stored on the mobile device and help the user to communicate payment information to the payment terminal using the correct protocol or data format. The mobile wallet application, when executed by the processor of the mobile device, typically presents the user with a graphical user interface (GUI) that allows the user to select a payment vehicle to use for a transaction from a plurality of payment vehicles stored in the mobile device, or in a mobile wallet chip/memory that may be integrated into the mobile device. The GUI may also allow the user to set certain payment preferences or mobile wallet preferences.

Thus, present embodiments of the invention disclosed in detail above provide systems, methods, and computer program products for making a financial transaction via a mobile device and providing a mobile wallet experience to effectively and efficiently manage a mobile wallet including financial institution sub-experiences. As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A mobile device for making a financial transaction comprising:
a memory device;
a user interface configured to present information to a user;
a communication device;
a processing device operatively coupled to the memory device and the communication device; and
a mobile wallet experience configured to:
display, via the user interface, a menu, the menu comprising options selectable to the user, the options comprising at least one financial institution sub-experience;
receive a menu selection request from the user to execute the at least one financial institution sub-experience;
generate a secure connection between the processing device and a secure module, the secure module being associated with the selected financial institution sub-experience;
display, via the user interface, the at least one financial institution sub-experience;
receive instructions from the user accessing the at least one financial institution sub-experience to transmit payment vehicle data to an external apparatus; and
transmit the payment vehicle data wirelessly to the external apparatus.

2. The mobile device of claim 1, wherein the apparatus is a mobile phone.

3. The mobile device of claim 1, wherein the secure module is integrated into a chip in the mobile device.

4. The mobile device of claim 3, wherein the secure module is stored in a memory in the chip.

5. The mobile device of claim 1, wherein the external apparatus is a terminal configured to perform contactless transactions.

6. The mobile device of claim 1, wherein the mobile device is configured to be capable of near field communication (NFC).

7. The mobile device of claim 1, wherein the external apparatus is a contactless payment terminal.

8. The mobile device of claim 1, wherein the external apparatus is an automated teller machine (ATM).

9. The mobile device of claim 1, wherein the options selectable to the user comprise more than one financial institution sub-experience.

10. The mobile device of claim 9, wherein the mobile device is configured such that processing device may generate a secure connection to a unique secure module for each financial institution sub-experience, each financial institution sub-experience and/or the associated secure module comprising data associated with at least one payment vehicle, the payment vehicle being authorized by the financial institution associated with the sub-experience.

11. The mobile device of claim 10, wherein a plurality of secure modules are present on the same chip.

12. The mobile device of claim 10, wherein a plurality of secure modules are distributed on more than one chip.

13. The mobile device of claim 9, wherein each financial institution sub-experience is configured to be compatible with the mobile wallet experience.

14. The mobile device of claim 13, wherein the mobile wallet experience is further configured to:
receive instructions from the user to change menu selection from one financial institution sub-experience to a second financial institution sub-experience;
sever the secure connection between the processing device and the secure module; and
generate a second secure connection between the processing device and a second secure module, the second secure module being associated with the second financial institution sub-experience.

15. The mobile device of claim 1, wherein the mobile wallet experience is further configured to display, via the user interface, more than one financial institution sub-experience and payment vehicle data for payment vehicles not associated with any of the financial institution sub-experiences.

16. The mobile device of claim 1, wherein the mobile wallet experience is further configured to require security authorization from the user prior to displaying the menu, wherein no further security authorization is required to access the at least one financial institution sub-experience.

17. A method for making a financial transaction comprising:
executing, on a mobile device comprising a memory device, a user interface, a communication device, and a processing device, a mobile wallet experience, the mobile wallet experience comprising a menu of options selectable to a user, the options comprising at least one financial institution sub-experience;
select an option to engage a financial institution sub-experience;
select a payment vehicle to utilize for the financial transaction; and
transmit payment vehicle data associated with the payment vehicle wirelessly to an external apparatus.

18. The method of claim 17, wherein the mobile device is a mobile phone.

19. The method of claim 17, wherein, upon selecting to engage a financial institution sub-experience, a secure connection is formed between the processing device and a secure module.

20. The method of claim 19, wherein the secure module is integrated into a chip in the mobile device.

21. The method of claim 20, wherein the secure module is stored in a memory in the chip.

22. The method of claim 17, wherein the external apparatus is a terminal configured to perform contactless transactions.

23. The method of claim 17, wherein the mobile device is configured to be capable of near field communication (NFC).

24. The method of claim 17, wherein the external apparatus is a contactless payment terminal.

25. The method of claim 17, wherein the external apparatus is an automated teller machine (ATM).

26. The method of claim 17, wherein the options selectable to the user comprise more than one financial institution sub-experience.

27. The method of claim 26, wherein the mobile device is configured such that processing device may generate a secure connection to a unique secure module for each financial institution sub-experience, each financial institution sub-experience and/or the associated secure module comprising data associated with at least one payment vehicle, the payment vehicle being authorized by the financial institution associated with the sub-experience.

28. The method of claim 27, wherein a plurality of secure modules are present on the same chip.

29. The method of claim 27, wherein a plurality of secure modules are distributed on more than one chip.

30. The method of claim 26, wherein each financial institution sub-experience is configured to be compatible with the mobile wallet experience.

31. The method of claim 26, further comprising:
changing from engaging one financial institution sub-experience to engaging a second financial institution sub-experience.

32. The method of claim 31, wherein upon changing, a first secure connection between the processing device and a first secure module is severed, and a second secure connection between the processing device and a second secure module is formed, the second secure module being associated with the second financial institution sub-experience.

33. The method of claim 17, wherein the menu of options selectable to the user comprise more than one financial institution sub-experience and payment vehicle data for payment vehicles not associated with any of the financial institution sub-experiences.

34. The method of claim 17, wherein the mobile wallet experience requires security authorization from the user, wherein no further security authorization is required to access the at least one financial institution sub-experience.

35. A computer program product for making a financial transaction via a mobile device, the computer program product comprising a non-transitory computer-readable medium comprising computer program code instructions for:
executing, on a mobile device, a mobile wallet experience configured to be capable of presenting a menu of options selectable to a user, the options comprising more than one financial institution sub-experience, the financial institution sub-experiences being configured to be compatible with the mobile wallet experience such that a user may freely switch between financial institution sub-experiences without significant delay or conflict, the set of code configured to form a secure connection between a processing device and a secure module upon selection of a financial institution sub-experience by the user, the set of code being further configured to sever the connection between the processing device and the secure module upon instruction from the user to change from the financial institution sub-experience to a second financial institution sub-experience and generate a second secure connection to a second secure module, the second secure module being associated with the second financial institution sub-experience, the set of code being further configured to transmit payment vehicle data associated with a payment vehicle wirelessly to an external apparatus.

36. The computer program product of claim 35, wherein the mobile device is a mobile phone.

37. The computer program product of claim 35, wherein the secure modules are integrated into a chip in the mobile device.

38. The computer program product of claim 37, wherein the secure modules are stored in a memory in the chip.

39. The computer program product of claim 35, wherein the set of code is configured to transmit the payment vehicle data via near field communication (NFC).

40. The computer program product of claim 35, wherein the external apparatus is a contactless payment terminal.

41. The computer program product of claim 35, wherein the external apparatus is an automated teller machine (ATM).

42. The computer program product of claim 35, wherein the menu of options selectable to the user additionally comprise payment vehicle data for payment vehicles not associated with any of the financial institution sub-experiences.

43. The computer program product of claim 35, wherein the set of code is configured to require security authorization from the user to access the mobile wallet experience, wherein no further security authorization is required in order to access the financial institution sub-experiences.
